(19) United States
(12) Patent Application Publication
(10) Pub. No.: US 2018/0267614 A1
(43) Pub. Date: Sep. 20, 2018

(54) CONTROL SYSTEM FOR A TERMINAL DEVICE WITH TWO SENSORS AND POWER REGULATION

(71) Applicant: Swan Solutions Inc., Houston, TX (US)

(72) Inventors: Yaniv BOSHERNITZAN, Houston, TX (US); Ohad NEZER, Houston, TX (US)

(21) Appl. No.: 15/461,010

(22) Filed: Mar. 16, 2017

(51) Int. Cl. G06F 3/01; G06F 3/0346; G06F 3/038

(52) U.S. Cl. CPC G06F 3/017; G06F 3/038; G06F 3/0346

(57) ABSTRACT

The control system includes a housing on a mounting surface, an accelerometer sensor, an acoustic sensor, and a microcontroller unit. Contact interactions are detected by the accelerometer sensor to switch the acoustic sensor from slack status to active status. When the acoustic sensor is able to detect gestures concurrent with the accelerometer sensor, subsequent contact interactions are detected by both sensors to control a terminal device. The system can further include a server in communication with the accelerometer sensor and the acoustic sensor, and a terminal device in communication with the server. A subsequent contact interaction can be detected by both sensors as a gesture matching a data profile corresponding to a command for the terminal device. The acoustic sensor and the accelerometer sensor confirm each other so that inadvertent hits and background noise are filtered from subsequent contact interactions intended to be gestures for controlling.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a control system for a terminal device, such as a television, lighting fixture, thermostat or laptop. More particularly, the present invention relates to controlling the terminal device with gestures. Additionally, the present invention relates to more accurately distinguishing gestures from background environment and managing power consumption.

### 2. Description of Related Art Including Information Disclosed Under 37 CFR 1.97 and 37 CFR 1.98

With the development of electronic technology, output devices or terminal devices are used daily and are increasingly integrated with interactive features in order to enhance convenience and functionality. Users now can use a control system or controller, such as a remote control device, to adjust lights, curtains, a thermostat etc. Existing control systems include distinct remote control devices dedicated to and associated with the particular output or terminal device to be controlled. Remote control devices can also be associated with more than one terminal device, such as a master controller for electronics and a touchscreen computer tablet made integral with furniture or walls to control lighting and room temperature. Any computer with an interface (keyboard, mouse, touch pad or touchscreen) can be a remote control device for multiple terminal devices with smart technology. Mobile phones are also known to be enabled for controlling terminal devices, such as home security cameras and door locks. Another existing control system involves voice recognition technology.

Existing control systems have limitations. Each output or terminal device typically is associated with a respective remote control device, such as a controller for the cable box, a controller for the DVD player, and a controller for the sound mixer. An excessive number of controllers is needed in order to remotely control multiple devices. Furthermore, an individual controller is often misplaced or left in locations that are not readily accessible to the user. The user must search for a controller or change locations to access the controller. Additionally, voice recognition technology often requires cumbersome training sessions to calibrate for pronunciations and accents of each particular user. Furthermore, voice recognition technology is often impaired by background noise resulting in difficulties for that control system to recognize verbal commands. Additionally, the sound produced by voice commands may be obtrusive in many environments such as in a room where others are sleeping, or in a room while watching a movie.

For remote control devices associated with multiple terminal devices, for example, computer tablets with a touchscreen and computers with touchpads, remote control devices can be built into or integrated into furniture. Smart tables have been built with touchscreens that are able to receive touch-based gestures. In the case of integrating these touchscreen or touch pads into surfaces of structures such as furniture, the cost of the structure is significantly increased due to design modifications required to accommodate the remote control device, and the cost of the components and hardware. Furthermore, aesthetics are often affected. Appearances are altered when furniture, walls and surroundings are filled with touchscreens, touchpads, and other conspicuous devices. Integration of such hardware into furniture also requires the manufacturer to modify existing designs such that the hardware can be accommodated into the structure.

Prior art manual control systems range from buttons on a television remote controller to a touchscreen of a mobile phone. Simple gestures of pressing dedicated buttons and complex gestures of finger motions on a touchscreen are both used to control terminal devices. Various patents and publications are available in the field of these manual control systems.

U.S. Pat. No. 8,788,978, issued to Stedman et al on Jul. 22, 2014, teaches a gesture sensitive interface for a computer. The “pinch zoom” functionality is the subject matter, so that the detection of first and second interaction points, and the relative motion between the points are detected by sensors. A variety of sensors are disclosed to define the field, including a touch screen, camera, motion sensor, and proximity sensors.

World Intellectual Property Organization Publication No. WO2013165348, published for Bess on Nov. 7, 2013, describes a system with at least three accelerometers disposed in different locations of an area with a surface to capture respective vibration data corresponding to a command tapped onto the surface by a user. A processing system receives the vibration data from each accelerometer, identifying the command and a location of the user from the vibration data. A control signal based on the command and the location is generated.

U.S. Patent Publication No. 20140225824, published for Shpunt et al on Aug. 14, 2014, discloses flexible room controls. A control apparatus includes a projector for directing first light toward a scene that includes a hand of a user in proximity to a wall of a room and to receive the first light that is reflected from the scene, and to direct second light toward the wall so as to project an image of a control device onto the wall. A processor detects hand motions within the projected field.

U.S. Patent Publication No. 20120249416, published for Maciocci et al on Oct. 4, 2012, describes another projection system with gesture identification. The projector is a unit worn on the body of the user to project onto surfaces, such as walls and tables. Spatial data is detected by a sensor array. Additional rendering operations may include tracking movements of the recognized body parts, applying a detection algorithm to the tracked movements to detect a predetermined gesture, applying a command corresponding to the detected predetermined gesture, and updating the projected images in response to the applied command.

U.S. Patent Publication No. 20100019922, published for Van Loenen on Jan. 28, 2010, is the known prior art for an interactive surface by tapping. Sound detection is filtered and interpreted either in the system to be controlled or else in the sensors themselves. The direction of movement of a hand stroking the surface can be interpreted as a command to increase or decrease a parameter, such as the sound volume level of a television, for example. Determination of the position of the user's hand is unnecessary.

In other innovative systems, a control system can convert any independent mounting surface into a controller for a terminal device. A physically separate mounting surface, such as a wall or table surface, can be used to activate and deactivate a television or light fixtures, without the user touching either appliance. The control system includes a housing engaged to a mounting surface, a sensor and microcontroller unit within the housing, a server in communication with the sensor, and a terminal device in communication with the server. The terminal device is to be controlled by gestures associated with the mounting surface. The control system further includes a server in communication with the sensor, including but not limited to wifi, Bluetooth, local area network, wired or other wireless connection. The terminal device can be an appliance, lighting fixture or climate regulator.

For gestures associated with the mounting surface, there is a need to distinguish the gestures from background noise. When the sensor is an acoustic sensor, background noise can affect the ability of the control system to identify the gesture from ambient sounds. When the sensor is an accelerometer, accidentally colliding with the mounting surface or setting a coffee cup on the mounting surface can affect the ability of the control system to identify the gesture from inadvertent hits on the mounting surface. Additionally, the sensors require power in order to remain active for detecting gestures. In order to regulate power consumption, switching between an energy-saving mode and an active mode can save energy. There are needs to improve the control systems for accurately detecting gestures and saving energy.

It is an object of the present invention to provide a system and method for controlling a terminal device.

It is an object of the present invention to provide a system and method to control a terminal device with gestures, including but not limited to knocks.

It is another object of the present invention to provide a system and method to more accurately detect gestures.

It is still another object of the present invention to provide a system and method to distinguish gestures from background stimuli.

It is another object of the present invention to provide a system and method with two different sensors to identify gestures, including but not limited to knocks.

It is still another object of the present invention to provide a system and method to confirm a sensor with another sensor with an improved level of confidence.

It is an object of the present invention to provide a system and method to regulate power consumption by a slack mode and an active mode, said active mode requiring more power than said slack mode.

These and other objectives and advantages of the present invention will become apparent from a reading of the attached specification.

### BRIEF SUMMARY OF THE INVENTION

Embodiments of the present invention include a control system comprising a housing, an accelerometer sensor, an acoustic sensor, and a microcontroller. The housing has an engagement means for a mounting surface, and both the accelerometer sensor and acoustic sensor are contained within the housing. Each sensor forms a respective interactive zone defined by a range of the sensor, and each interactive zone is aligned with the mounting surface. Additionally, the acoustic sensor has a first power consumption level so as to be in a slack status and a second power consumption level so as to be in an active status. The slack status is a relatively lower power mode than the active status. The acoustic sensor is not devoid of activity; the acoustic sensor is resting, but still operating. The acoustic sensor generally stays in the slack status at the lower power consumption level, while the accelerometer sensor remains in a respective active status. The system saves energy with the acoustic sensor in the slack status and with other components in respective slack statuses.

A contact interaction associated with the mounting surface within the accelerometer interactive zone is detected by the accelerometer sensor as accelerometer data signals. The contact interaction is also within the acoustic interactive zone, but the acoustic sensor is in slack status so the contact interaction is not detected by the acoustic sensor. However, the microcontroller unit is contained within the housing and connected to the accelerometer sensor. The microcontroller unit receives the accelerometer data signals from the accelerometer sensor and determines a status data pattern corresponding to the accelerometer data signals of the contact interaction. The status data pattern can match a status gesture profile associated with a command to switch the acoustic sensor from the slack status to the active status. The microcontroller toggles the acoustic sensor to the active status, and the control system is ready to detect a subsequent contact interaction with both the accelerometer sensor and the acoustic sensor.

Another embodiment of the control system includes a server and a terminal device. The subsequent contact interactions control a terminal device, when the acoustic sensor is in the active status. The server in communication with the accelerometer sensor and the acoustic sensor can include a routing module, a processing module being connected to the routing module, and an output module connected to the processing module. The terminal device includes a receiving module in communication with the output module of the server and means for initiating activity of the terminal device. The subsequent accelerometer data signals and acoustic data signals from the subsequent contact interaction determine a subsequent data pattern, which is transmitted to the server. The subsequent data pattern matches with a gesture profile. This gesture profile is associated with a command for the terminal device.

The control system of the present invention has an accelerometer sensor that remains in an active status at a low power consumption level of the control system. The user can awaken the control system with a gesture detected by only the accelerometer sensor to switch the acoustic sensor into an active status. Thus, the control system is now at a full power consumption level, instead of a low power consumption level, so as to detect subsequent gestures for terminal devices with both the accelerometer sensor and the acoustic sensor. Other components of the system can be awakened to corresponding active statuses. Also, the interaction of the acoustic sensor with the accelerometer sensor can filter background noise and inadvertent hits on the mounting surface. A sound detected by the acoustic sensor without a vibration detected by the accelerometer is now filtered from subsequent contact interactions intended to be gestures. Similarly, accidental bumps on the mounting surface are vibrations without a sound corresponding to a subsequent contact interaction intended to be a gesture. The present invention improves accuracy of detecting gestures and saves energy by limiting the powering of both sensors, until activated for listening for gestures.

Embodiments of the present invention include the method of power regulation of a system for controlling a terminal device. The method includes installing a housing of the system on a mounting surface by an engagement device, the housing being comprised of an accelerometer sensor, an acoustic sensor, and a microcontroller unit. The acoustic sensor has a first power consumption level so as to be in a slack status and a second power consumption level so as to be in an active status. The system consumes less power when the acoustic sensor is in the slack status and when the microcontroller is in a corresponding slack status. When initially activated, the system has the acoustic sensor and other components, such as the microcontroller, in respective slack statuses, and only the accelerometer sensor is in an active status.

The method further includes making a physical impact on the mounting surface so as to generate a contact interaction and detecting the contact interaction as accelerometer data signals with the accelerometer sensor. The microcontroller unit receives the accelerometer data signals to determine a status data pattern and commands the acoustic sensor to switch from the slack status to the active status, when the status data pattern matches a status gesture profile. With the acoustic sensor in the active status, the system is now fully activated and powered for a subsequent contact interaction within a set time duration. The method also includes switching the active status back to the slack status when the subsequent contact interaction occurs after the set time duration passes.

Embodiments of the method include connecting a server in communication with the accelerometer sensor and the acoustic sensor and connecting the terminal device in communication with the server. The system with the acoustic sensor in active status can detect the subsequent contact interactions. Making a subsequent physical impact on the mounting surface generates a subsequent contact interaction, when the acoustic sensor is in the active status and before the set time duration passes. Subsequent accelerometer data signals and acoustic data signals determine a subsequent data pattern. The server matches the subsequent data pattern to a gesture profile associated with a command for the terminal device. The command is sent to the terminal device for performing the activity according to the command. Each of the subsequent accelerometer data signals and the acoustic data signals confirm each other to more accurately determine the subsequent data pattern. The background noise and extraneous vibrations to the mounting surface are filtered for a more accurate subsequent data pattern.

### BRIEF DESCRIPTION OF THE SEVERAL VIEWS OF THE DRAWINGS

FIG. 1 is a schematic view of an embodiment of the control system of the present invention with the accelerometer sensor and the acoustic sensor.

FIG. 2 is a top plan view of another embodiment of the housing with the accelerometer sensor and the acoustic sensor on the mounting surface of the present invention.

FIG. 3 is flow diagram of the embodiment of the method for power regulation of the control system of the present invention showing the slack status and the active status of the acoustic sensor.

FIG. 4 is a schematic view of another embodiment of the control system of the present invention with the server and terminal device.

FIG. 5 is flow diagram of the embodiment of the method for controlling a terminal device in the ready mode, according to the embodiment of the present invention of FIG. 4.

### DETAILED DESCRIPTION OF THE INVENTION

The control system of the present invention regulates power and improves accuracy of gesture detection. To better distinguish gestures from background noise and accidental vibrations, the control system of the present invention includes two sensors, in particular an accelerometer sensor and an acoustic sensor. The vibrations detected by the accelerometer are compared with the sounds detected by the acoustic sensor in order to more accurately identify an intentional gesture from extraneous stimuli. The accelerometer detects a vibration on the mounting surface, and the acoustic sensor confirms a corresponding sound to determine the data pattern. A vibration on the mounting surface, caused by an accidental bump, can no longer be confused as a data pattern for a gesture, such as an intentional knock. Furthermore, a sound without a vibration on the mounting surface can no longer be confused as a data pattern for a gesture. The power requirements for two sensors and processing data signals from two sensors can be high. The power requirements for connecting to a server can also be high. The present invention further accounts for power regulation with a control system with toggling between an activated and fully powered system and an activated and power saving system.

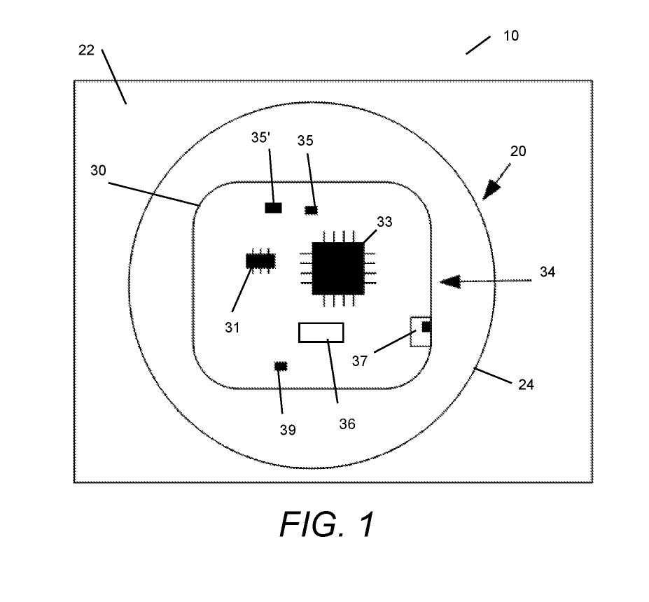

FIGS. 1-3 show the control system 10 with the housing 20 comprised of an engagement means 24 for a mounting surface 22. Planar surfaces, such as tables and walls, as well as non-planar surfaces, such as beds, can be mounting surfaces 22. There is a rigid positioning of the accelerometer sensor unit 35 and the acoustic sensor unit 35′ relative to the mounting surface 22 through the housing 20. Any sound or vibration or both of the mounting surface 22 is transmitted to the accelerometer sensor unit 35 and the acoustic sensor unit 35′. The engagement means 24 attaches the accelerometer sensor unit 35 and the acoustic sensor unit 35′ and reduces damping so that the accelerometer sensor unit 35 and the acoustic sensor unit 35′ more accurately detect contact interactions 60 on the mounting surface 22.

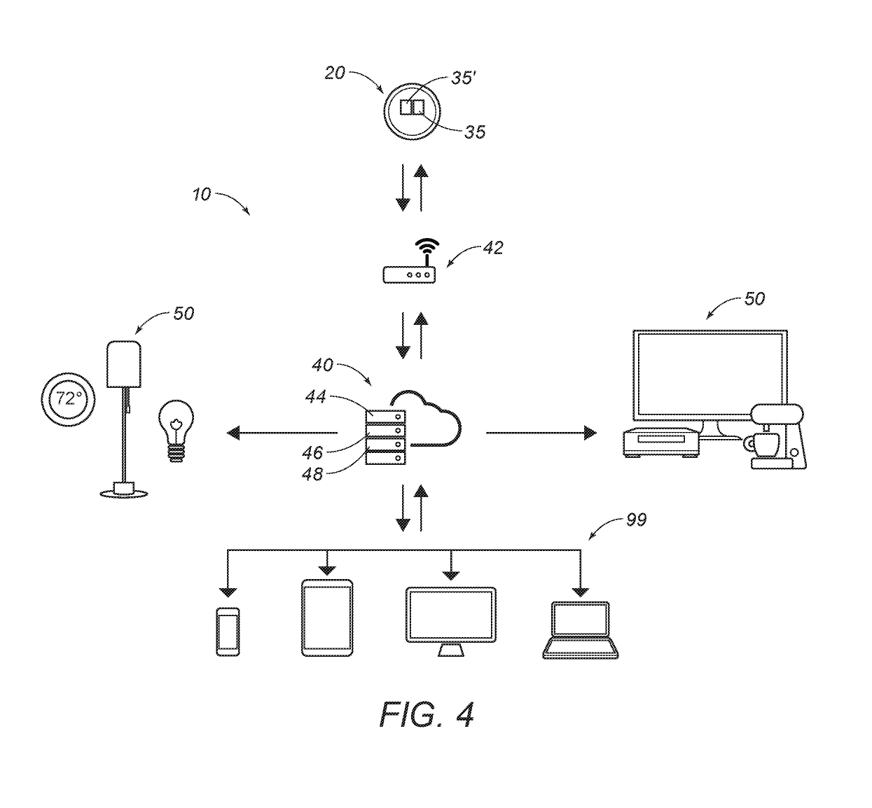

The control system 10 of the present invention includes an accelerometer sensor 35 and an acoustic sensor 35′ as shown in FIG. 1. The housing 20 contains the printed circuit board 30 comprised of a board 34 with a flash memory 31, microcontroller unit (MCU) 33, the accelerometer sensor unit 35, the acoustic sensor unit 35′, antenna 37, and light emitting diode 39. The microcontroller unit 33 and antenna 37 can have wifi capability for communication with a server 40 (See FIG. 4). The microcontroller unit 33 is connected to the accelerometer sensor unit 35, the acoustic sensor unit 35′, and the flash memory 31. The rigid position of the printed circuit board 30 establishes the transmission of the contact interaction to the accelerometer sensor unit 35 and the acoustic sensor unit 35′. The engagement means 24 is in a fixed position relative to the accelerometer sensor unit 35 and the acoustic sensor unit 35′. Other parts in the housing 20 include batteries 36 as a known power supply for the control system 10. The batteries 36 power both the accelerometer sensor unit 35 and the acoustic sensor unit 35′. The stable construction of the housing 20 and the accelerometer sensor unit 35 and the acoustic sensor unit 35′ enable the accurate and efficient conversion of the contact interactions 60 as gestures into commands for a terminal device 50 (See FIG. 4).

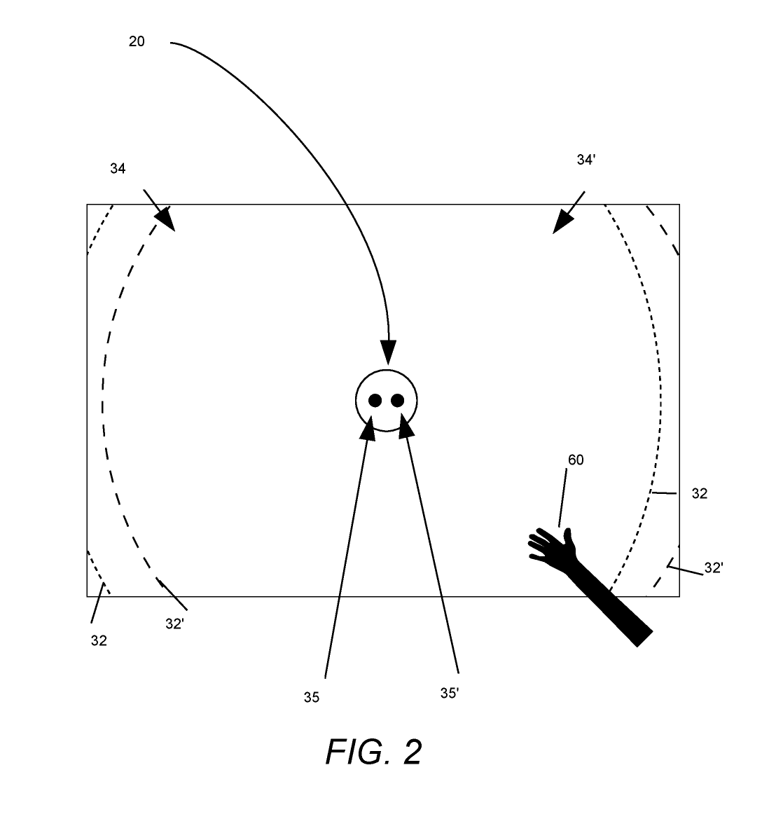

In this embodiment of the control system 10, FIG. 2 shows the accelerometer sensor unit 35 and the acoustic sensor unit 35′ forming respective zones 32, 32′. The accelerometer sensor unit 35 forms an accelerometer interactive zone 32 defined by an accelerometer range 34 of the accelerometer sensor 35. A contact interaction 60 with the mounting surface 22 within the accelerometer interactive zone 32 is detected by the accelerometer sensor unit 35 as accelerometer data signals 70. The acoustic sensor unit 35′ forms an acoustic interactive zone 32′ defined by an acoustic range 34′ of the acoustic sensor unit 35′. A contact interaction with the mounting surface 22 within the acoustic interactive zone 32′ is detected by the acoustic sensor unit 35′ as acoustic data signals. The accelerometer interactive zone 32 of the accelerometer sensor unit 35 overlaps with the acoustic interactive zone 32′ of the acoustic sensor unit 35′. FIG. 2 shows the interactive zones 32, 32′ aligned with the mounting surface 22, in particular, the interactive zones 32, 32′ are coplanar with the mounting surface 22. The contact interaction 60 on the mounting surface 22 can be detected by the accelerometer sensor unit 35 and the acoustic sensor unit 35′ on the mounting surface 22.

In the present invention, the acoustic sensor unit 35′ has a first power consumption level so as to be in a slack status and a second power consumption level so as to be in an active status. In the activated and fully powered control system 10, the acoustic sensor unit 35′ is in the active status, and both sensor units 35, 35′ detect the respective data signals. The microcontroller 33 permits communication to a server in the activated and fully powered control system 10. In the activated and power saving control system 10, the acoustic sensor 35′ is in the slack status, and only the accelerometer sensor unit 35 detects respective data signals. Other components of the control system 10, such as the microcontroller 33, can also be in respective slack status for lower power consumption. For example, the microcontroller 33 is not transmitting to the server 40 in the corresponding slack status of the microcontroller for one type of lower power consumption. In the deactivated control system 10, both sensor units 35, 35′ are off.

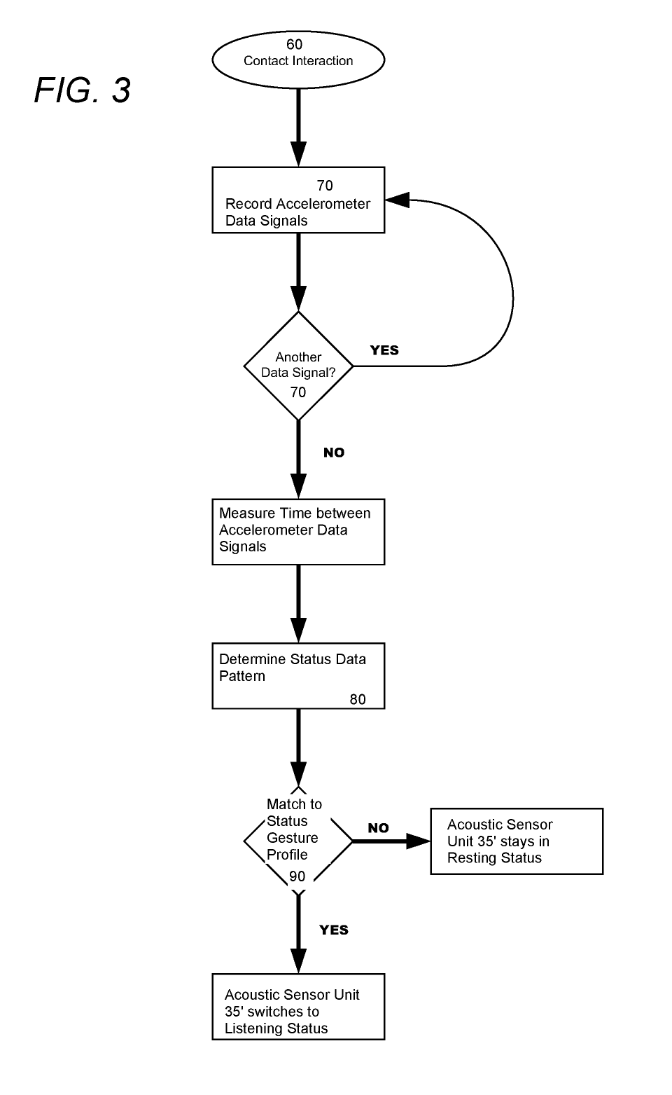

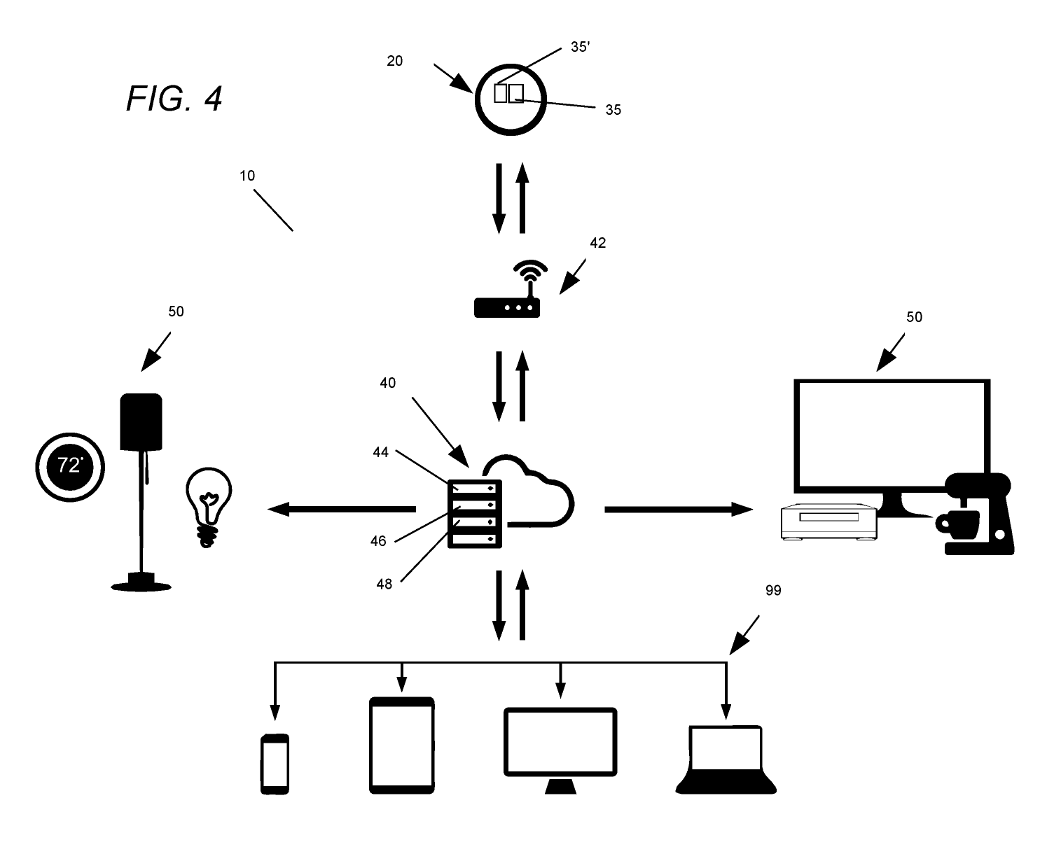

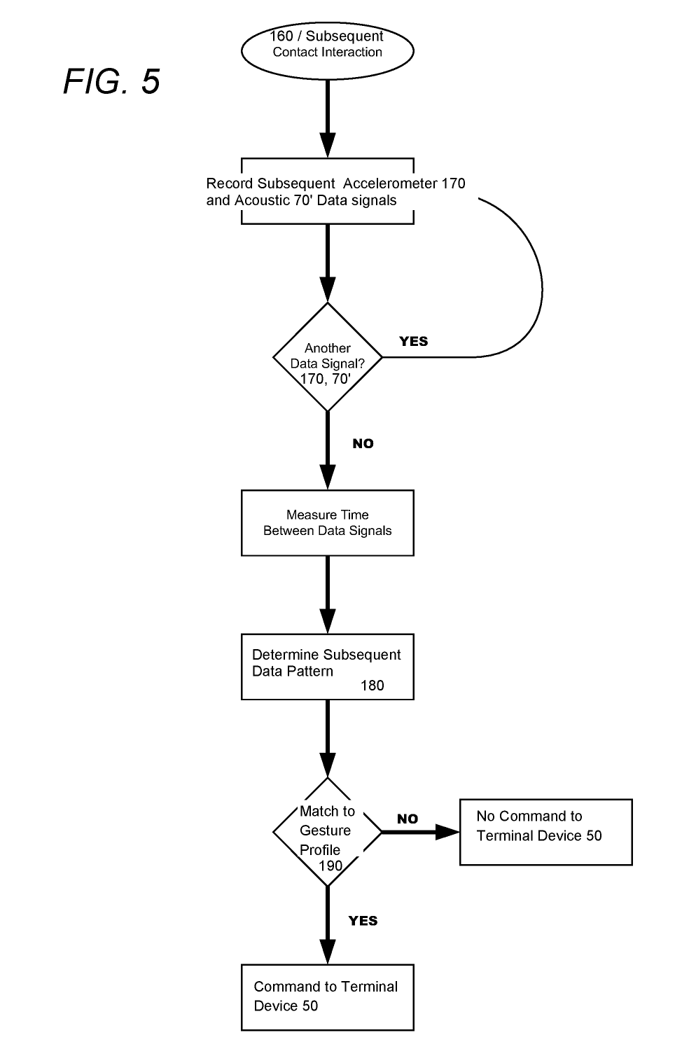

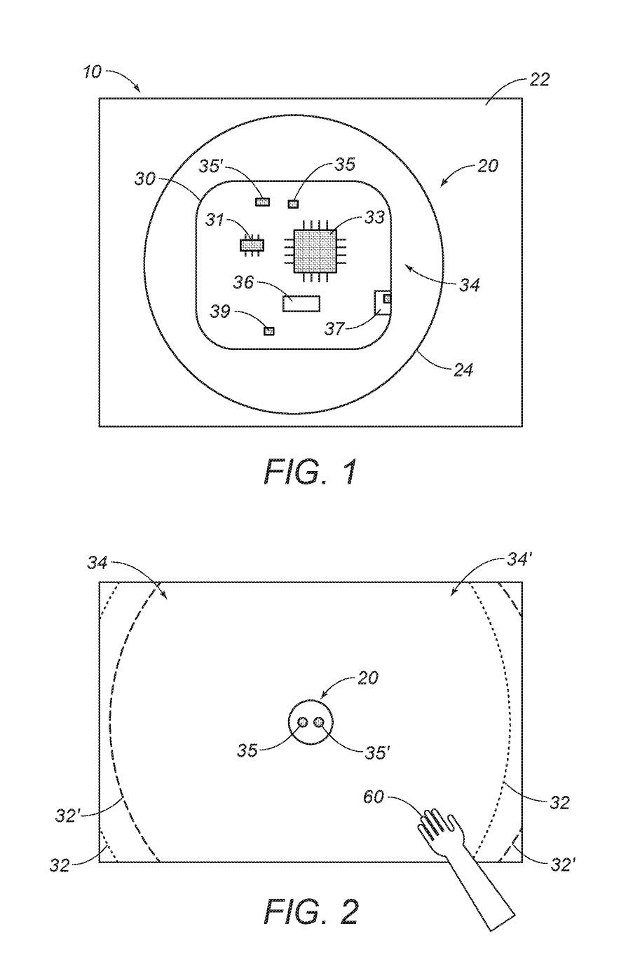

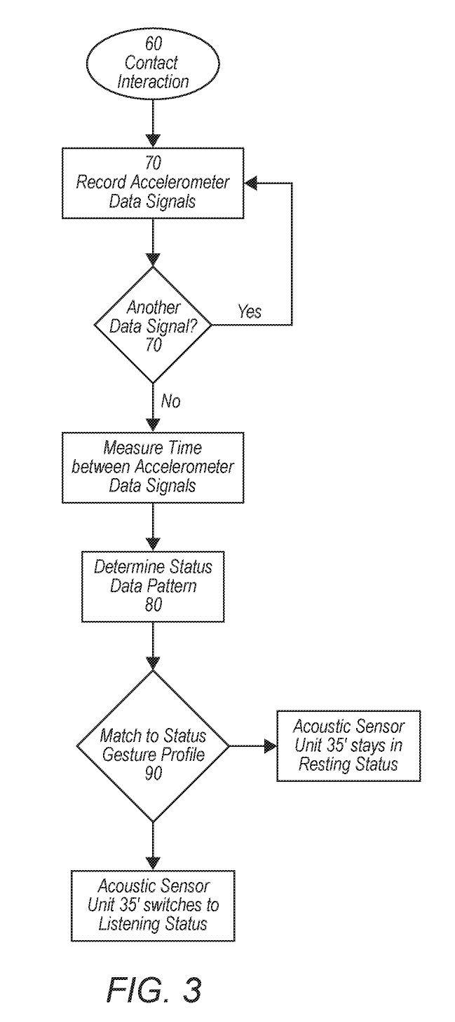

The control system 10 regulates power with the acoustic sensor unit 35′ and the microcontroller unit 33 in relation to the accelerometer sensor unit 35. FIG. 3 is a flow diagram of an embodiment of the present invention, showing the accelerometer data signals 70 of the accelerometer sensor unit 35 in relation to the microcontroller unit 33. The contact interaction 60 generates the data signals 70 of the accelerometer sensor unit 35 through the housing 20. In the present invention, the contact interaction 60 is comprised of an impact or plurality of impacts associated with the mounting surface 22. In some embodiments, the impact or plurality of impacts on the associated surface is the contact interaction 60, not an impact on the mounting surface 22. The impacts are coordinated or correspond or translate to the mounting surface 22 for detection by the accelerometer sensor unit 35 through the mounting surface 22 as accelerometer data signals 70.

According to FIG. 3, the microcontroller unit 33 receives the accelerometer data signals 70 from the accelerometer sensor unit 35. These accelerometer data signals 70 correspond to the contact interaction 60 associated with the mounting surface 22. The microcontroller unit 33 determines the accelerometer data pattern 80 corresponding to the accelerometer data signals 70 of the contact interaction 60. The microcontroller unit 33 also matches the status data pattern 80 with a status gesture profile 90. The status gesture profile 90 is associated with a switch command to change the status of the acoustic sensor unit 35′ and other components of the control system 10, such as enabling communication with a server by the microcontroller unit 33. The control system 10 as the activated power saving system has lower power consumption as an energy saving or sleep or slack mode. However, control system 10 remains able to detect the contact interaction 60 corresponding to the status gesture profile 90. The control system 10 remains ready to change into the higher power consumption as an activated and fully powered system. The control system 10 can power the microcontroller unit 33 to connect to the server 40 as the activated and fully powered system (See FIG. 4). The status gesture profile 90 can be comprised of a threshold level for the status data pattern 80. Any data pattern above the threshold level matches the status gesture profile 90.

The control system 10 remains able to detect the contact interaction 60 corresponding to the status gesture profile 90, such that the control system 10 can toggle between the slack status and active status of the acoustic sensor unit 35′ by gestures. An elderly person in a wheelchair is able to regulate turning on or turning off the control system 10 by knocking twice on a tabletop instead of locating a dedicated button on the housing 20. The control system 10 is not required to maintain high power consumption. Both sensor unit 35, 35′ are not drawing power at the same time.

In the embodiments of the control system 10, the accelerometer data signals 70 have a respective defined peak corresponding to each impact, a measured time period between each defined peak, and a defined time period after a last defined peak. Each peak is a distinct spike in the data being detected with a quick increase from a baseline or background activity. An accelerometer data pattern 80 for each contact interaction 60 is determined by each defined peak and the defined time period after the last defined peak, and each measured time period between each defined peak, if there is a plurality of impacts. FIG. 3 shows an embodiment for the contact interaction 60 comprised of one impact or a plurality of impacts. A single knock or a sequence of knocks can be a contact interaction 60. The control system 10 determines the accelerometer data pattern 80 for contact interactions 60 comprised of a single tap, three quick knocks, two taps, and other sequences. Contact interactions 60, such as tapping, knocking, sweeping, and dragging, can be detected by the accelerometer sensor unit 35 as accelerometer data signals 70.

The relationship between the microcontroller 33 and the acoustic sensor unit 35′ is timed. The toggle to active status of the acoustic sensor unit 35′ is limited by time. Only subsequent contact interactions within a set time duration maintain the active status of the acoustic sensor 35′. The control system 10 distinguishes between accidentally switching to active status and purposely switching to active status and the higher power consumption level. Once switched, the user must make a subsequent contact interaction within a predetermined amount of time, so that the subsequent contact interaction is detected by both sensor units 35, 35′. The control system 10 prevents accidental powering of the acoustic sensor unit 35′ and avoids unnecessary power consumption.

Now that the control system 10 can be set as an activated and fully powered system, the control system 10 is ready to detect subsequent contact interactions for controlling the terminal device. The subsequent contact interactions will be detected as subsequent accelerometer data signals and acoustic data signals. There will be two sets of data signals to determine a subsequent data pattern, and the server can determine a command for the terminal device with a particular processing of the subsequent data pattern from the two sets of data signals. The interaction allows for more accurate detection of gestures with inadvertent hits and background noise being more easily filtered from intentional gestures for the control system 10.

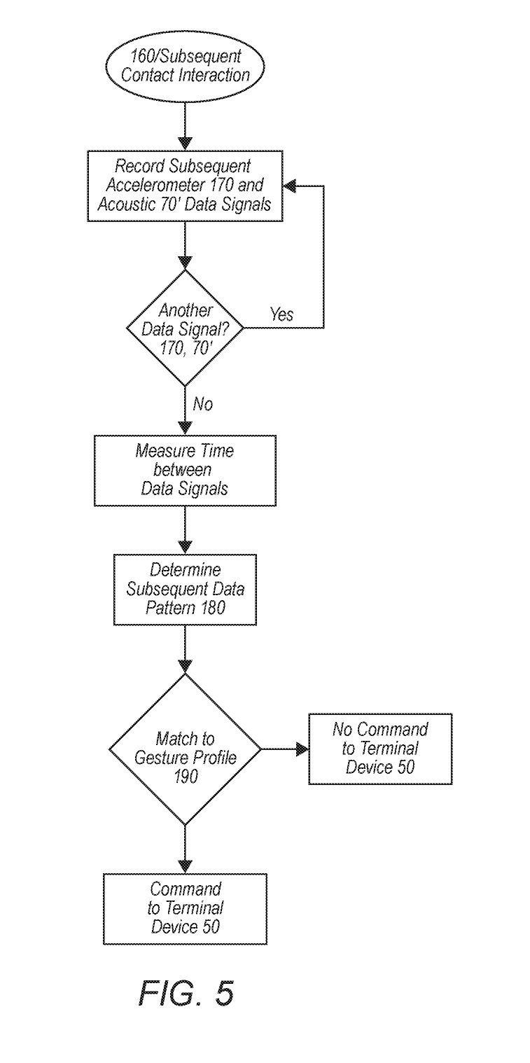

FIG. 4-5 show an alternative embodiment of the invention, with the control system 10 including a housing 20, an accelerometer sensor unit 35 and an acoustic sensor unit 35′ within the housing 20, a server 40 in communication with the sensor units 35, 35′, and a terminal device 50 in communication with the server 40. Interfaces 99 are connected to the server 40 in order to interact with the control system 10. The interfaces 99 can include computers, laptops, tablets and smartphones. FIG. 4 shows a variety of different interfaces 99. The interfaces 99 allow the user to adjust the settings of the control system 10. Gestures by a user associated with the mounting surface 22 regulate the control system 10 and control the terminal devices 50. In some embodiments, the devices that are interfaces 99 could also be terminal devices 50. The server 40 is in communication with the sensor units 35, 35′, when the system is an activated and fully powered system. The communication can be wireless or wired. The connection between the server 40 and the sensor units 35, 35′ can include a router 42, as shown in FIG. 4, and may also include wifi, Bluetooth, local area network, or other connections. In FIG. 4, the server 40 can be comprised of a routing module 44, a processing module 46 being connected to the routing module 44, and an output module 48 connected to the processing module 46.

The flow chart of FIG. 5 shows the control system 10 controlling activity of a terminal device 50 by a subsequent contact interaction 160. The routing module 44 receives the subsequent accelerometer data signals 170 from the accelerometer sensor unit 35 and the acoustic data signals 70′ from the acoustic sensor unit 35′. These subsequent accelerometer data signals 170 and acoustic data signals 70′ correspond to other subsequent contact interactions 160 associated with the mounting surface 22, when the acoustic sensor unit 35′ is in active status. The processing module 46 determines the subsequent data pattern 180 corresponding to the subsequent accelerometer data signals 170 and acoustic data signals 70′ of the subsequent contact interaction 160. The processing module 46 also matches the subsequent data pattern 180 with a gesture profile 190. The gesture profile 190 is associated with a command for the terminal device 50, such as power off or change channels or dim intensity. Then, the output module 48 transmits the command to the terminal device 50. For example, when the terminal device 50 is a television, another contact interaction 160 of three fast knocks can be detected as subsequent accelerometer data signals 170 and acoustic data signals 70′ to generate a subsequent data pattern 180. The subsequent data pattern 180 can be matched to a gesture profile 190 associated with changing channels up one channel. The output module 48 communicates the command to change channels up one channel through the server 40 to the television as the terminal device 50. Thus, that same elderly person in a wheelchair is able to activate the control system 10 by knocking so that the person can change channels by knocking twice on a tabletop instead of locating a dedicated button on the television or fiddling with a touchscreen on a smartphone.

In the control system 10, the terminal device 50 can be an appliance, such as a television, stereo or coffee machine. Alternatively, the terminal device 50 may be a device running software, a light or climate regulator, such as a thermostat, fan or lighting fixture. The activity of the terminal device 50 depends upon the terminal device 50. The activity is dedicated to the particular terminal device 50. The command associated with the gesture profile 190 relates to the particular terminal device 50. Knocking twice on a tabletop can be converted by the control system 10 into a command to change channels on a television or to lower the temperature of a thermostat or to create an entry in an online calendar software program on a computer. The control system 10 can also be used with multiple terminal devices 50. A gesture profile 190 for a command is specific for an activity for a particular terminal device 50. More than one terminal device 50 can be connected to the server 40 to receive the commands from gestures by the user against the mounting surface 22.

In the embodiments of the control system 10, each of the subsequent accelerometer data signals 170 and the acoustic data signals have a respective defined peak corresponding to each impact, a measured time period between each defined peak, and a defined time period after a last defined peak. These peaks correspond to vibration data for the accelerometer sensor unit 35 and sound data for the acoustic sensor unit 35′. Each peak is a distinct spike in the data being detected with a quick increase from a baseline or background activity. The subsequent data pattern 180 for each subsequent contact interaction 160 is determined by each defined peak and the defined time period after the last defined peak, and each measured time period between each defined peak, if there is a plurality of impacts.

FIG. 5 shows an embodiment for the subsequent contact interaction 160 comprised of one impact or a plurality of impacts. A single knock or a sequence of knocks can be a subsequent contact interaction 160. The control system 10 determines the subsequent data pattern 180 for subsequent contact interactions 160 comprised of a single tap, three quick knocks, two taps, and other sequences. Subsequent contact interactions 160, such as tapping, knocking, sweeping, and dragging, can be detected by the accelerometer sensor unit 35 and acoustic sensor unit 35′.

In the present invention, each defined peak and the defined time period after the last defined peak, and each measured time period between each defined peak of the acoustic data signals 70′ confirm each defined peak and the defined time period after the last defined peak, and each measured time period between each defined peak of the subsequent accelerometer data signals 170. If a user knocks twice and then sets a glass down, the accelerometer detects three identical vibrations and the acoustic sensor, such as a microphone, detects the first two vibrations as from a first object and the surface (the users hand knocking twice) and the third vibration as from a second object and the surface (setting glass down) because the third sound was different from the first two sounds. The unwanted signals from the glass being set down are filtered with a degree of accuracy beyond the prior art. Setting a bag on a tabletop may cause a vibration to be detected by the accelerometer sensor unit 35 and a sound detected by the acoustic sensor unit 35′. Knocking on a tabletop by the user as an intentional gesture may cause the same vibration to be detected by the accelerometer sensor unit 35 and a respective sound detected by the acoustic sensor unit 35′. The control system 10 can now distinguish setting the bag on the tabletop from knocking as an intentional gesture to control the terminal device 50. The data pattern of setting the bag on the tabletop can generate a vibration analogous to the vibration of knocking as the intentional gesture, but the respective sound of the knocking as the intentional gesture is different. Thus, the data pattern of setting the bag no longer matches the subsequent data pattern of the knocking as an intentional gesture.

The present invention prioritizes the accelerometer data signals to confirm the contact interaction in the accelerometer interactive zone, not the acoustic interactive zone. With an acoustic sensor, the acoustic interactive zone overlaps the mounting surface, but the acoustic interactive zone may be too large and detects too many sounds not associated with a subsequent contact interaction. A sound can be heard, but the origin of the location of the sound can be difficult to screen. Filtering the acoustic data signals with the accelerometer sensor unit requires too much power and processing time. The present invention selects a particular hierarchy of the sensors, server and microcontroller unit. The accelerometer sensor unit 35 relates to the acoustic sensor unit 35′, microcontroller unit 33 and the server 40 to regulate power and more accurately determine subsequent data patterns for commands to the terminal devices.

The present invention provides an improved system and method for controlling a terminal device. A user can make gestures to control activity of a terminal device, such as knocking against a wall to illuminate an overhead light. Reliably detecting gestures with a sensor is more complicated than simply activating an accelerometer or microphone to capture vibration and sound data. Extraneous stimuli, like background noise and inadvertent vibrations, interfere with identifying intentional vibrations and sounds intended to be gestures for controlling the terminal device. To filter knocking in the interactive zone from extraneous stimuli, the control system of the present invention sets an accelerometer sensor unit, an acoustic sensor unit, a microcontroller, and a server in particular relationship to more accurate detect the intentional gestures. The acoustic sensor confirms the accelerometer sensor unit to insure the location of the gesture in the accelerometer interactive zone. The control system further regulates power consumption with the interaction of the two sensors and the microcontroller. Although needed for more accurate detection of gestures, the power demands on the system with two sensors cannot be so easily sustained. The present invention regulates power consumption by an activated and powered and an activated and power saving system coordinated with the two sensors of the control system.

As described herein, the invention provides a number of advantages and uses, however such advantages and uses are not limited by such description. Embodiments of the present invention are better illustrated with reference to the Figure(s), however, such reference is not meant to limit the present invention in any fashion. The embodiments and variations described in detail herein are to be interpreted by the appended claims and equivalents thereof.

The foregoing disclosure and description of the invention is illustrative and explanatory thereof. Various changes in the details of the illustrated structures, construction and method can be made without departing from the true spirit of the invention.

We claim:

1. A control system comprising:
a housing having an engagement means for a mounting surface;
an accelerometer sensor contained within the housing, the accelerometer sensor forming an accelerometer interactive zone defined by a range of the accelerometer sensor, the accelerometer interactive zone being aligned with the mounting surface, the accelerometer sensor being in a fixed position relative to the engagement means;
an acoustic sensor contained within the housing, the acoustic sensor forming an acoustic interactive zone defined by an acoustic range of the acoustic sensor, the acoustic interactive zone being aligned with the mounting surface, the acoustic sensor being in a fixed position relative to the engagement means, the acoustic sensor having a first power consumption level so as to be in a slack status and a second power consumption level so as to be in an active status;
wherein the accelerometer interactive zone of the accelerometer sensor overlaps with the acoustic interactive zone of the acoustic sensor, and
wherein a contact interaction associated with the mounting surface within the accelerometer interactive zone is detected by the accelerometer sensor as accelerometer data signals; and
a microcontroller unit being contained within the housing and connected to the accelerometer sensor,
wherein the microcontroller unit receives the accelerometer data signals from the accelerometer sensor and determines a data pattern corresponding to the data signals of the contact interaction,
wherein the microcontroller unit matches the data pattern with a status gesture profile, the status gesture profile being associated with a command to switch the acoustic sensor from the slack status to the active status, the active status corresponding to the acoustic sensor having the second power consumption level, the second power consumption level being higher than the first power consumption level,
wherein a subsequent contact interaction detected by the accelerometer sensor and the acoustic sensor controls a terminal device, when the acoustic sensor is in the active status, and
wherein the microcontroller maintains the acoustic sensor in the active status for all subsequent contact interactions within a set time duration.

2. The control system, according to claim 1, wherein the contact interaction is comprised of an impact on the mounting surface, the accelerometer data signals having a respective defined peak corresponding to each impact and a defined time period after a last defined peak, the status data pattern being comprised of each defined peak and the defined time period after the last defined peak.

3. The control system, according to claim 1, wherein the contact interaction is comprised of a plurality of impacts on the mounting surface, the accelerometer data signals having a respective defined peak corresponding to each impact, a measured time period between each defined peak, and a defined time period after a last defined peak, the status data pattern being comprised of each defined peak, each measured time period, and the defined time period after the last defined peak.

4. The control system, according to claim 1, wherein the subsequent contact interaction is associated with the mounting surface within the accelerometer interactive zone and detected by the accelerometer sensor as subsequent accelerometer data signals and by the acoustic sensor as acoustic data signals, the control system further comprising:
a server in communication with the accelerometer sensor and the acoustic sensor, the server being comprised of a routing module, a processing module being connected to the routing module, and an output module connected to the processing module, the routing module receiving a subsequent data pattern related to the subsequent accelerometer data signals from the accelerometer sensor and the acoustic data signals from the acoustic sensor, the subsequent data pattern corresponding to the subsequent accelerometer data signals and the acoustic data signals of the subsequent contact interaction, the processing module matching the subsequent data pattern with a gesture profile, the gesture profile being associated with a command; and
a terminal device being comprised of a receiving module and means for initiating activity of the terminal device corresponding to the command, the terminal device being in communication with the server, the output module transmitting the command to the receiving module.

5. The control system, according to claim 4, wherein the subsequent contact interaction is comprised of another impact on the mounting surface, each of the subsequent accelerometer data signals and the acoustic data signals having a respective defined peak corresponding to each impact and a defined time period after a last defined peak, the subsequent data pattern being comprised of each defined peak and the defined time period after the last defined peak, and
wherein each defined peak and the defined time period after the last defined peak of the acoustic data signals confirms each defined peak and the defined time period after the last defined peak of the subsequent accelerometer data signals for each subsequent data pattern.

6. The control system, according to claim 4, wherein the subsequent contact interaction is comprised of a plurality of impacts on the mounting surface, each of the subsequent accelerometer data signals and the acoustic data signals having a respective defined peak corresponding to each impact, a measured time period between each defined peak, and a defined time period after a last defined peak, the subsequent data pattern being comprised of each defined peak, each measured time period, and the defined time period after the last defined peak, and
wherein each defined peak, each measured time period, and the defined time period after the last defined peak of the acoustic data signals confirms each defined peak, each measured time period, and the defined time period after the last defined peak of the subsequent accelerometer data signals for each subsequent data pattern.

7. The control system, according to claim 1, wherein the accelerometer data signals are comprised of vibration data of the contact interaction.

8. The control system, according to claim 4, wherein the subsequent accelerometer data signals are comprised of vibration data of the subsequent contact interaction, and wherein the acoustic data signals are comprised of sound data of the subsequent contact interaction.

9. The control system, according to claim 4, wherein the terminal device is comprised of one device selected from a group consisting of: a television, a thermostat, a computer, a software system, a game console, a fan, a mattress adjustor, an alarm clock, and a lighting fixture.

10. The control system, according to claim 4, wherein the activity of the terminal device is one selected from a group consisting of powering the terminal device, changing channels, regulating volume, regulating temperature, regulating brightness, scrolling a screen, and switching activity status.

11. A method of power regulation of a system for controlling a terminal device, the method comprising the steps of:
installing a housing on a mounting surface by an engagement device, the housing being comprised of an accelerometer sensor contained within the housing, an acoustic sensor contained within the housing, and a microcontroller unit connected to the accelerometer sensor and the acoustic sensor, the accelerometer sensor forming an accelerometer interactive zone defined by a range of the accelerometer sensor, the accelerometer interactive zone being aligned with the mounting surface, the accelerometer sensor being in a fixed position relative to the engagement device, the acoustic sensor forming an acoustic interactive zone defined by an acoustic range of the acoustic sensor, the acoustic interactive zone being aligned with the mounting surface, the acoustic sensor being in a fixed position relative to the engagement device, the acoustic sensor having a first power consumption level so as to be in a slack status and a second power consumption level so as to be in a active status, the acoustic sensor being in the active status;
making a physical impact on the mounting surface so as to generate a contact interaction with the acoustic sensor in the slack status;
detecting the contact interaction as accelerometer data signals with the accelerometer sensor;
receiving the accelerometer data signals from the accelerometer sensor with the microcontroller unit;
determining a status data pattern corresponding to the accelerometer data signals of the contact interaction with the microcontroller unit;
matching the status data pattern to a status gesture profile with the microcontroller unit, the status gesture profile being associated with a command to switch the acoustic sensor from the slack status to the active status, the active status corresponding to the second power consumption level, the second power consumption level being higher than the first power consumption level;
receiving the command and switching the acoustic sensor to the active status;
controlling a terminal device, when the acoustic sensor is in the active status;
maintaining the acoustic sensor in the active status for a subsequent contact interaction within a set time duration; and
switching the active status to the slack status when the subsequent contact interaction occurs after the set time duration passes.

12. The method for power regulation, according to claim 11, wherein the step of making a physical impact on the mounting surface further comprises making a plurality of physical impacts on the mounting surface, the contact interaction being associated with more than one physical impact.

13. The method for power regulation, according to claim 11, wherein the status gesture profile is comprised of a threshold level for the status data pattern, wherein any status data pattern above the threshold level matches the status gesture profile

14. The method of power regulation, according to claim 11, wherein the step of controlling the terminal device further comprises the steps of:
connecting a server in communication with the accelerometer sensor and the acoustic sensor, the server being comprised of a routing module, a processing module being connected to the routing module, and an output module connected to the processing module;
connecting the terminal device in communication with the server, the terminal device being comprised of a receiving module;
making a subsequent physical impact on the mounting surface so as to generate the subsequent contact interaction, when the acoustic sensor is in the active status and before the set time duration passes;
detecting the subsequent contact interaction as subsequent accelerometer data signals with the accelerometer sensor and acoustic data signals with the acoustic sensor;
determining a subsequent data pattern corresponding to the subsequent accelerometer data signals and the acoustic data signals of the subsequent contact interaction;
transmitting said subsequent data pattern to said processing module of said server;
matching the subsequent data pattern to a gesture profile with the processing module, the gesture profile being associated with a command;
transmitting the command to the receiving module of terminal device with the output module of the server, the command corresponding to activity of the terminal device; and
performing the activity with the terminal device.

15. The method for power regulation, according to claim 14, wherein the step of making the subsequent physical impact on the mounting surface further comprises making a plurality of physical impacts on the mounting surface, the subsequent contact interaction being associated with more than one physical impact.

16. The method for power regulation, according to claim 14, wherein the step of determining the subsequent data pattern comprises confirming the subsequent accelerometer data signals with the acoustic data signals.

17. The method for power regulation, according to claim 14, each of the subsequent accelerometer data signals and the acoustic data signals having a respective defined peak corresponding to each impact and a defined time period after a last defined peak, the subsequent data pattern being comprised of each defined peak and the defined time period after the last defined peak, wherein the step of determining the subsequent data pattern comprises:
confirming each defined peak and the defined time period after the last defined peak of the acoustic data signals with each defined peak and the defined time period after the last defined peak of the subsequent accelerometer data signals for each subsequent data pattern.
